(19) United States
(12) Patent Application Publication
(10) Pub. No.: US 2006/0288359 A1
(43) Pub. Date: Dec. 21, 2006

(54) Optical disc drive apparatus, method of controlling the position of optical pickup unit, method for detecting an device for reading and/or writing of a disc

(75) Inventors: Ivon Franciscus Helwegen, Eindhoven (NL); Henricus Renatus Martinus Verberne, Eindhoven (NL); Mohammed Meftah, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/533,722

(22) PCT Filed: Oct. 15, 2003
(86) PCT No.: PCT/IB03/04575

§ 371 Date: May 3, 2005

(30) Foreign Application Priority Data
Nov. 6, 2002 (EP) 02079630.6

(51) Int. Cl. G11B 7/00

(52) U.S. Cl. 720/663

(57) ABSTRACT

Device for reading of and/or writing on a disc. The device is provided with at least one shaft (2, 3) and a carrier (10) movable along said shaft. The carrier is provided with at least one actuator (14) which is electrically connected to a control device (16). The actuator is electrically connected to said control device by means of said shaft.

The invention relates to a device for reading and/or writing of a disc, which device is provided with at least one shaft extending along a centerline and a carrier which is displaceable over said shaft and is provided with at least one actuator, said actuator being electrically connected to a control device.

Such a device known from American patent application US-A1-2002/0021631 is suitable for use in a Compact Disc (CD) or Digital Video Disc (DVD), whereby optical discs can be read and/or written. For this purpose, a lens is controlled by the actuator such that a laser beam can be radially corrected by means of the lens and can be focused, so that the laser beam is positioned in a desired location of the disc, and the disc as a result can be read and/or written. The actuator is controlled by a control device. To keep the weight of the carrier as low as possible, the control device will usually be arranged in the solid world. The control device arranged in the solid world is electrically connected to the actuator.

A disadvantage of such a known device is that the electrical connection between the actuator and the control device located in the solid world is achieved by means of a cable connection, which cable connection occupies comparatively much space. A further disadvantage of a cable connection between the control device and the actuator is that the cable connection may intercept the laser beam.

It is an object of the present invention to provide a device in which the actuator is electrically connected to the control device in a simple manner.

This object is achieved in the device according to the invention in that the actuator is electrically connected to the control device by means of said shaft.

The shaft of the device according to the present invention thus has a dual function: firstly, the shaft serves as a mechanical guide for the carrier that is displaceable over the shaft, and secondly, the shaft provides an electrical conduction between the actuator situated on the carrier and the control device in the solid world. An advantage of this is that the electrical connection between the actuator and the control device occupies substantially no additional space and cannot cause any interception of the laser beam.

An embodiment of the device according to the invention is characterized in that the carrier is displaceably supported with respect to the shaft by means of at least one bearing, while the actuator is connected to the shaft with electrical conduction via said bearing.

The bearing provides both a good mechanical guide and a good electrical conduction.

An alternative embodiment of the device according to the invention is characterized in that the bearing is connected to the shaft with electrical conduction under spring force.

An advantage of such an embodiment is that the bearing can slide over the shaft with comparatively low friction, while at the same time the bearing makes electrical contact with the shaft in a simple manner.

A yet further embodiment of the device according to the invention is characterized in that the actuator is connected to the shaft with electrical conduction through the carrier.

The connection between the shaft and the actuator can also be realized without loose cables in this manner.

A further embodiment of the device according to the invention is characterized in that the shaft comprises at least two shaft segments which are electrically separated from one another.

Such an embodiment has the advantage that a different control signal can be sent from the control device to the actuator through each shaft segment.

A still further embodiment of the device according to the invention is characterized in that the bearing comprises at least two bearing segments which are electrically separated from one another, each electrically conductive bearing segment of the bearing being in contact with an associated shaft segment of the shaft.

An advantage of such an embodiment is that such a construction of the bearing corresponding to that of the shaft achieves an electrical contact between the control device and the actuator in which the different control signals can be passed on in a simple manner.

A yet different embodiment of the device according to the invention is characterized in that the bearing segments and shaft segments extend parallel to the centerline.

Such an embodiment has the advantage that a good electrical connection is safeguarded over the full length of the shaft in a simple manner.

A yet further embodiment of the device according to the invention is characterized in that a lens can be positioned by means of the actuator.

The lens can be accurately positioned by means of the electrical connection via the shaft between the control device and the actuator.

The invention will be explained in more detail by way of example with reference to the accompanying drawings, in which:

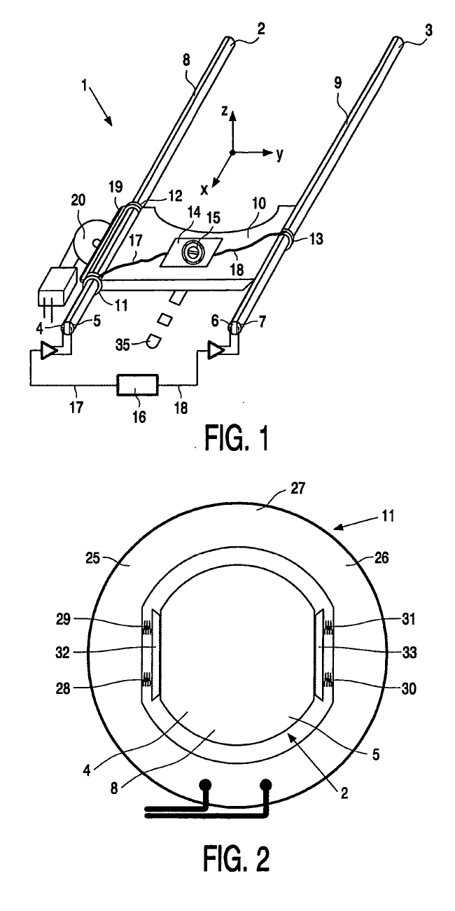

FIG. 1 is a perspective view from above of a device according to the invention, and

FIG. 2 is a cross-sectional view on an enlarged scale of a guide element and a bearing of the device shown in FIG. 1.

Corresponding components have been given the same reference numerals in the Figures.

FIG. 1 shows a device 1 according to the present invention which is suitable for reading and/or writing of, for example, an optical disc (not shown), such as a Compact Disc (CD) or Digital Video Disc (DVD). The device 1 is provided with two shafts 2, 3 which are mutually parallel. The shafts 2, 3 are each provided with two shaft segments 4, 5 and 6, 7, respectively, which extend parallel to the centerline of the shaft 2, 3. The shaft segments 4, 5 and 6, 7 are separated by respective insulation layers 8, 9 which extend over the full lengths of the shafts. A carrier 10 is supported between the shafts 2, 3 by three bearings 11, 12, 13, such that the three bearings 11, 12, 13 have a sufficient mechanical stability and experience as little friction as possible during the mechanical displacement over the shafts 2, 3. An actuator 14 capable of controlling a lens 15 in and opposed to directions indicated by arrows X, Y, and Z is present on the carrier 10. The electrical connection between the actuator 14 and respective shaft segments 4, 5 and 6, 7 is achieved through the electrically conductive bearings 11, 13, as will be explained in more detail with reference to FIG. 2. A control device 16 is connected to the actuator 14 situated on the carrier 10 via two electrical circuits 16, 18. The electrical circuits 17, 18 extend from the control device 16 through the respective shaft segments 4, 5 and 6, 7 and the electrically conductive bearings 11 and 13 via the carrier 10 to the actuator 14. A signal can be sent to the actuator 14 through each of the electrical circuits 17 and 18.

A connecting rod 19 is situated between two bearings 11, 12 provided on the shaft 2, which rod is connected to a drive means 20 by which the carrier 10 can be displaced in and opposed to the direction indicated by arrow X.

FIG. 2 is an enlarged cross-section of the shaft 2 and the bearing 11 of the device 1. The bearing 11 is provided with two electrically conductive bearing segments 25, 26 which are mutually separated by an insulating layer 27. The electrically conductive bearing segments 25, 26 are connected to the shaft 2 with electrical conduction via springs 28, 29, 30, 31 and sliding contact plates 32, 33.

The operation of the device 1 will now be briefly explained. If a disc extending parallel to the shafts 2, 3 is to be read and/or written, a laser beam 35 must be accurately aimed at the disc. To achieve a comparatively large displacement of the carrier 10 and the actuator 14 and lens 15 situated thereon with respect to the disc, the carrier 10 is displaced by the drive means 20 in and opposed to the direction indicated by arrow X over the shafts 2, 3. The lens 15 is displaced relative to the carrier 10 by the actuator 14 to achieve a comparatively small displacement necessary for a focusing and radial positioning of a laser beam 35 originating from a laser (not shown). The actuator 14 is controlled by the control device 16 for this purpose. A radial displacement of the lens 15 in and opposed to the direction indicated by arrow X is controlled via the electrical circuit 17, and focusing of the lens 15 in and opposed to the direction indicated by arrow Z is controlled via the electrical circuit 18. Corrections in the Y-direction take place through rotation of the disc to be read or written.

It is possible to have more than one signal pass through the shafts 2, 3 in that the shaft is subdivided into a plurality of shaft segments obtained by means of a plurality of insulation layers. The bearing should then be adapted accordingly.

Carbon brushes may alternatively be used as sliding contact surfaces for the electrical conduction between the contact faces of the electrical bearing and the shaft.

In the claims:

1. A device for reading and/or writing of a disc, which device is provided with at least one shaft extending along a centerline and a carrier which is displaceable over said shaft and is provided with at least one actuator, said actuator being electrically connected to a control device, characterized in that the actuator is electrically connected to the control device by means of said shaft.

2. A device as claimed in claim 1, characterized in that the carrier is displaceably supported with respect to the shaft by means of at least one bearing, while the actuator is connected to the shaft with electrical conduction via said bearing.

3. A device as claimed in claim 2, characterized in that the bearing is connected to the shaft with electrical conduction under spring force.

4. A device as claimed in claim 1, characterized in that the actuator is connected to the shaft with electrical conduction through the carrier.

5. A device as claimed in claim 2, characterized in that the shaft comprises at least two shaft segments which are electrically separated from one another.

6. A device as claimed in claim 5, characterized in that the bearing comprises at least two bearing segments which are electrically separated from one another, each electrically conductive bearing segment of the bearing being in contact with an associated shaft segment of the shaft.

7. A device as claimed in claim 6, characterized in that the bearing segments and shaft segments extend parallel to the centerline.

8. A device as claimed in claim 1, characterized in that a lens can be positioned by means of the actuator.
